(19) United States
(12) Patent Application Publication
(10) Pub. No.: US 2006/0006149 A1
(43) Pub. Date: Jan. 12, 2006

(54) Jointed hollow arc gouging rod

(75) Inventors: Michael Shawn Toops, Cedar Park, TX (US); Mingsheng Zhu, Suzhoujie (CN)

Correspondence Address: Kelly K. Kordzik;Winstead Sechrest & Minick P.C., P.O. Box 50784, Dallas, TX, 75201, US

(73) Assignees: Flame Technologies, Inc., Cedar Park, TX (US); Beijing Advanced Metal Material Co., Ltd.

(21) Appl. No.: 11/083,614

(22) Filed: Mar. 18, 2005

(30) Foreign Application Priority Data
Mar. 18, 2004 (CN) 200420007246.3

(51) Int. Cl. B23K 9/013

(52) U.S. Cl. 219/69.1

(57) ABSTRACT

A jointable hollow carbon rod used for arc gouging includes one or more hollow carbon rods joined together end-to-end. Because of the hollow nature of the rods, more electrical current can be delivered to the rods, resulting in significantly faster material removal. Since the rods are jointable, the arc gouging process can continue for a longer period of time before the jointed rods are consumed by the arc gouging process.

The present Application claims priority to Chinese Patent Application No. 200420007246.3, filed Mar. 18, 2004.

### TECHNICAL FIELD

The present invention relates in general to arc gouging, and in particular, to carbon arc gouging.

### BACKGROUND INFORMATION

In carbon arc cutting or gouging, an arc is established between a carbon-graphite electrode and a metal workpiece to be cut or gouged. Metal removal is continuous as the carbon arc is advanced within the cut. Such a process is used for severing and gouging, the gouging being sometimes used for weld groove preparation and for the removal of a weld root or a defective weld zone. The working end or tip of the electrode is heated to a high temperature by the arc current. The electrode is consumed during the process, the carbon being lost by oxidation or sublimation of the tip. Carbon arc cutting requires an electrode holder, cutting electrodes, a power source, and often an air supply. The arc is struck by lightly touching the electrode to the workpiece and withdrawing it to the proper distance in accordance with the arc voltage requirements. The gouging technique is different from that of arc welding in that metal is removed instead of deposited. The proper arc length is maintained by moving the electrode in the direction of the cut fast enough to keep up with the metal removal.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an illustration of an arc gouging rod in accordance with an embodiment of the present invention;

FIG. 2 shows a cross-section of a portion of the rod illustrated in FIG. 1;

FIG. 3 illustrates a cross-section of the entire rod illustrated in FIG. 1; and

FIG. 4 illustrates a jointed rod configured in accordance with the present invention in use for gouging a workpiece.

### DETAILED DESCRIPTION

In the following description, numerous specific details are set forth to provide a thorough understanding of the present invention. However, it will be obvious to those skilled in the art that the present invention may be practiced without such specific details.

Refer now to the drawings wherein depicted elements are not necessarily shown to scale and wherein like or similar elements are designated by the same reference numeral through the several views.

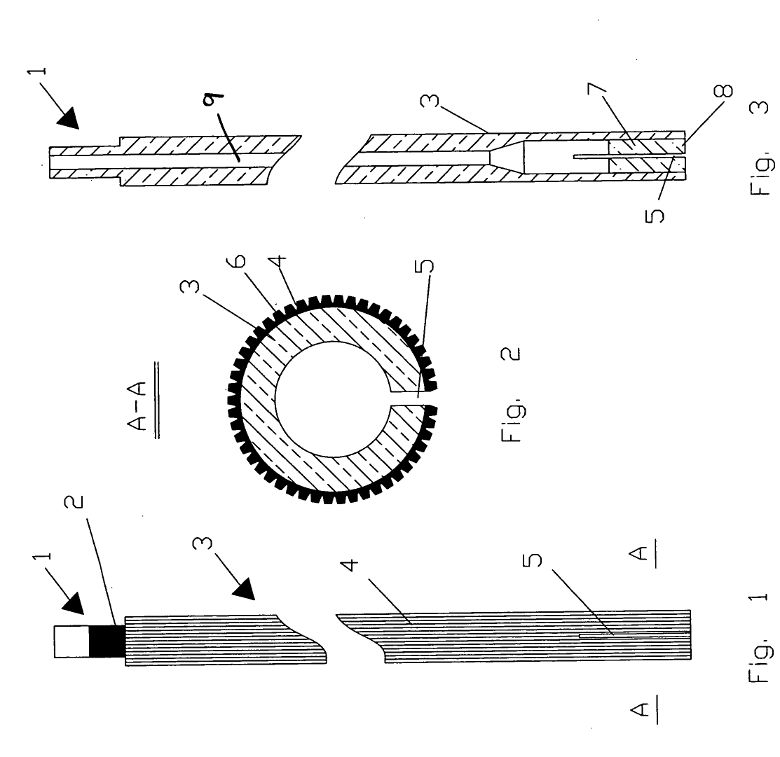

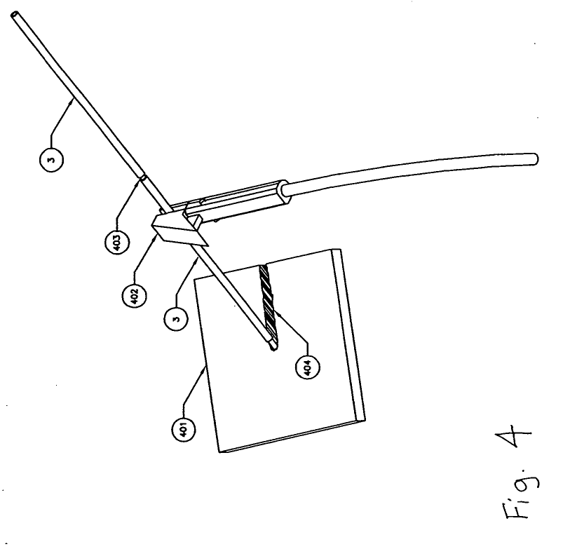

Referring to FIGS. 1-3, there is illustrated a jointable hollow carbon rod with ribs in accordance with an embodiment of the present invention. Carbon rod 3 includes a tenon (male end) 1 at one end of the rod, which is adaptable for fitting inside a rabbeted hole (female end) 8 of another rod so that two or more rods can be jointed together end to end. The rabbet hole 8 (also known as a mortise hole) includes an opening slot 5 so that tenon 1 fits snuggly within rabbet hole 8, thus permitting the rabbet hole 8 to expand a bit while the tenon is inserted.

A copper plating layer 4 may be deposited on the outside of the rod 3, with the outside layer 4 of the rod having ribs 6 for increasing the electrical conductivity of the rod 3. Such a copper layer is also partially inside of the rabbet hole 8 as shown by label 7.

Running through the inside of rod 3 is a hollow core 9. On a solid core gouging rod, the electrode forms a point as the electrode is consumed. This point on the end of the solid core gouging rod restricts/limits the ability to conduct electricity, since there is very little surface area at the tip of the solid gouging rod. Since there is no center on a hollow core rod, as the hollow core electrode is consumed, it can not form a point. The electricity on a hollow core rod is spread on the outer and inner ring surfaces at the tip of the hollow core gouging rod. This increased surface area allows the hollow core rods to conduct significantly more electricity than a solid core rod, resulting in a faster, more efficient arc gouging process. Note that the hollow core 9 may be continuous throughout the rod 3, or a series of disjointed hollow cores.

The rods 3 are adaptable for joining end-to-end, so that a particular arc gouging process can be continued for a longer period of time before the rod is consumed. Referring to FIG. 4, there is illustrated two rods 3 jointed together end-to-end at joint 403. Electrical current is supplied to the jointed rods 3 by clamp 402 in a well known manner. The jointed hollow rods 3 are then utilized to gouge workpiece 401, creating gouged portion 404. Since the jointed rods 3 are longer than a single rod 3, the arc gouging process may be continued for a longer period of time before the jointed rods 3 become merely an unusable stub, resulting in an ability for the person doing the process to create a more continuous gouge 404.

There are several difficulties in the manufacturing process of hollow, jointed carbon gouging rods as compared to the manufacturing process of hollow, non-jointed rods or solid, jointed rods. While none of the challenges presented in the individual features of hollow, jointed gouging rods are difficult individually, it is the combination of the features: 1) Jointed and 2) Hollow that when combined, resulted in a difficult manufacturing challenge. Below is a detailed explanation of the manufacturing steps, which required extensive testing and process development to produce a functioning, safe, and reliable hollow, jointed ribbed carbon gouging rod. Adding the ribbed feature can even further increase the manufacturing difficulty.

A key to a quality, reliable jointed solid carbon gouging rod is the interface between the two rods. Each rod has a round tenon feature at one end of the rod and a mating round mortise hole (also known as a rabbet hole) at the other end of the rod. Rods are joined together by inserting the round tenon feature into the mortise hole of a second rod. This joint holds the rods together via static friction created from the tapered interference fit of the mating features. Most designs incorporate two slots, diametrically opposed on the mortise joint, to allow slight expansion of the mortise joint. A tolerance must be maintained to create enough interference fit to hold the two rods together, but not too much interference which can result in cracking of the brittle carbon material. With solid jointed gouging rods, the manufacturing process for the joint features is not significantly difficult. However, when adding the additional requirement of the hollow feature of the hollow, jointed gouging rods, the center-hole of the hollow rod compromises some of the mechanical strength of both the round tenon feature and mating mortise hole.

The hollow center of the rods created cracking of the walls of the mortise hole, which was not encountered with standard solid jointed rods. To overcome this issue, the extrusion pressure is increased to 600 tons, resulting in a denser, stronger carbon material. The number of expansion slots in the wall of the mortise hole has been reduced from two slots to one slot. The single slot provides more strength, but also minimizes the amount of available deflection to accommodate the mating round tenon. The tolerances of the inner and outer dimensions/angles of the mortise wall needed to be more precise, which requires minimizing temperature variability and better packing of raw rods in curing boxes during the curing process in order to produce straighter rods. The straighter rods allow for more precise machining of the inner and outer dimensions of the mortise hole walls, and when combined with the single expansion slot results in a tighter toleranced but mechanically stronger joint.

The hollow center also created mechanical failure at the base of the tenon feature of the hollow rods, which was not encountered with standard solid jointed rods. To overcome this issue, the extrusion pressure is increased to 600 tons, resulting in denser, stronger carbon material. The tolerances of the hollow tenon outer surface as well as the concentric location of the center hole need to be more precise to provide uniform thickness and strength of the hollow tenon wall (this was not an issue with a solid, jointed rod). The tighter tolerances of the outer round hollow tenon surface required minimizing temperature variability and better packing of raw rods in curing boxes during the curing process in order to produce straighter rods. The straighter rods allow for more precise machining of the outer dimensions of the mortise hole walls. To tighten the axial location of the center hole in the region of the tenon, tighter tolerances of the extrusion process and dies are also required, which are further complicated by the ribbed feature and the increased 600 ton extrusion pressures.

Combining the hollow, jointed features also creates several difficulties during the copper plating process. After the curing process and before the copper plating process, wax has to be added to plug the center-hole, while not covering certain portions of the tenon and mortise joints. This requires significant testing to balance the need of the copper plating (for electrical conductivity) with the need for no copper plating on portions of the mating surfaces of the tenon and mortise joints (to maintain tight interference fit tolerances on the mating surfaces). After the copper plating, the wax needs to be removed from the center hole.

While the manufacturing processes of hollow, non-jointed rods or solid, jointed rods is not significantly difficult individually, combining these two features in a hollow, jointed rod provides many manufacturing challenges. Overcoming these manufacturing challenges requires in-depth manufacturing engineering and testing to tighten the tolerances of the manufacturing processes and produce a more precise and stronger hollow, jointed gouging rod.

Although the present invention and its advantages have been described in detail, it should be understood that various changes, substitutions and alterations can be made herein without departing from the spirit and scope of the invention as defined by the appended claims.

What is claimed is:

1. A jointable hollow arc gouging rod comprising:
a cylindrical medial portion having at least a portion with an internal cavity;
a male end connected to a first end of the medial portion; and
a female end connected to a second end of the medial portion, wherein the male end and female end are configured for connecting in an end-to-end arrangement with another similarly configured rod.

2. The rod as recited in claim 1, wherein the cylindrical medial portion, the male end, and the female end have an internal cavity, either continuous or a series of disjointed hollow cores.

3. The rod as recited in claim 1, wherein the male end includes a tenon, and the female end includes a rabbeted hole, wherein the tenon of a first rod is configured to mate with the rabbeted hole of a second rod.

4. The rod as recited in claim 3, wherein an outside surface of the medial portion is ribbed.

5. An arc gouging apparatus comprising:
a first hollow cylindrical rod having a male end; and
a second hollow cylindrical rod having a female end, wherein the male end is inserted into the female end so that the first and second rods are joined end-to-end.

6. The apparatus as recited in claim 5, wherein the male end is a tenon, and the female end is a cavity on one end of the second rod.

7. The apparatus as recited in claim 6, wherein the first and second rods both have similarly configured male and female ends.

8. An arc gouging apparatus comprising:
a first hollow cylindrical rod; and
a second hollow cylindrical rod, wherein the first and second hollow cylindrical rods each have means for joining the rods in an end-to-end manner.
